(19) United States
(12) Patent Application Publication
(10) Pub. No.: US 2024/0221036 A1
(43) Pub. Date: Jul. 4, 2024

(54) CONSULTANT MATCHING SYSTEM

(71) Applicant: One Sobo, LLC, Atlanta, GA (US)

(72) Inventor: Robert T Burke, Jr., Atlanta, GA (US)

(73) Assignee: One Sobo, LLC, Atlanta, GA (US)

(21) Appl. No.: 18/092,117

(22) Filed: Dec. 30, 2022

(51) Int. Cl. G06Q 30/02

(52) U.S. Cl. CPC G06Q 30/0281

(57) ABSTRACT

A method comprises providing a user access to data associated with a client, receiving an analysis of the data from the user, receiving a user category associated with the analysis from the user, and generating an insight that includes the analysis and the user category associated with the analysis. The method further comprises associating the user with the insight, storing the insight in a memory, and outputting the insight to the client.

### BACKGROUND

The present invention relates to a consulting matching system. Consulting is an activity that uses experienced persons “consultants” to advise businesses or other organizations on how to operate a variety of aspects of their business. For example, an organization may have poor performance in marketing and sales. The organization may hire a consultant who specializes in marketing and sales to assist the business in improving their marketing and sales activities. In other examples, an organization may have a poor financial status. A financial consultant may be used to improve the financial status and processes of the organization.

Many organizations, particularly small or medium sized organizations, may not need a consulting team or a full-time consultant to address their needs. Often such organizations hire a fractional consultant. A fractional consultant is a consultant who works on a part-time basis. For example, a financial consultant may work ten hours per week for a small or medium sized organization—a fraction of a full-time position.

Identifying consulting needs and finding a consultant that matches the needs of an organization may be challenging.

### SUMMARY

Embodiments of the present invention are directed to a method that comprises providing a user access to data associated with a client, receiving an analysis of the data from the user, receiving a user category associated with the analysis from the user, and generating an insight that includes the analysis and the user category associated with the analysis. The method further comprises associating the user with the insight, storing the insight in a memory, and outputting the insight to the client.

A system comprises a processor communicatively connected to a memory and a display, the processor operative to provide a user access to data associated with a client, receive an analysis of the data from the user, and receive a user category associated with the analysis from the user. The system is further operative to generate an insight that includes the analysis and the user category associated with the analysis, associate the user with the insight, store the insight in a memory, and output the insight to the client.

A non-transitory computer readable medium including the instructions to provide a user access to data associated with a client, receive an analysis of the data from the user, receive a user category associated with the analysis from the user, and generate an insight that includes the analysis and the user category associated with the analysis. The instructions are further operative to associate the user with the insight, store the insight in a memory, and output the insight to the client.

### BRIEF DESCRIPTION OF THE DRAWINGS

FIG. 1 illustrates a block diagram of an example computer system.

FIG. 2 illustrates a block diagram of an exemplary method for pairing users with clients.

FIG. 3 illustrates a block diagram of another exemplary method for pairing users with clients.

### DETAILED DESCRIPTION

Although this disclosure includes a detailed description of a computing environment, the teachings herein are not limited to the described computing environment. In embodiments, any implementation of a computer environment may be used whether now understood or later developed.

As discussed above companies or organizations may use consultants or advisors to assist the organizations with correcting problems in their businesses and to help the organizations run their businesses or operations. Such assistance may be for financial or funding assistance, management help, logistics, operations or sales and marketing help among others. Some organizations hire a full-time consultant or a team of consultants. Other organizations may hire a part-time or fractional consultant. Identifying a full-time consultant may be easier than identifying a fractional consultant because full-time consultants often advertise their services more prominently. Full time consultants are often assigned to large scale projects that are usually undertaken by large organizations. The consulting needs of smaller organizations are often resolved by small scale projects that generally require less consulting time. Identifying qualified consultants that match the needs of an organization may become particularly challenging when desiring a fractional or part-time consultant.

In this regard, large organizations typically hire the most consultants and have more experience and better resources to identify their needs and find a qualified consultant. Further, many small and medium-sized organizations may fail to understand what business processes may be improved by a consultant. In other words, some organizations may not know what their problems are let alone who to hire to solve their problems.

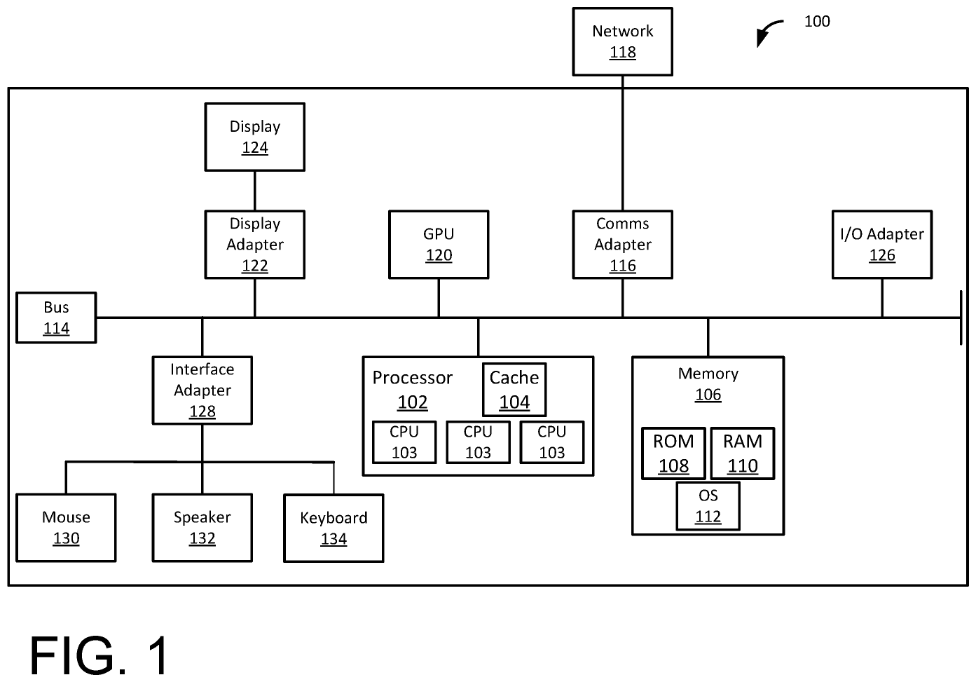

FIG. 1 illustrates a block diagram of an example computer system 100. In embodiments, a microprocessor is arranged in a personal computer, workstation, minicomputer, or mainframe computer. Embodiments system 100 a mobile device or part of a mobile device.

The computer 100 includes processor 102 communicatively connected to an input/output (I/O) adapter 126, memory 106, a communications adapter 116, an interface adapter 128, a display adapter 122, and a graphics processing unit (GPU) 120 via a system bus 114.

The processor 102 includes any number of central processing units (CPU) 103 and a cache memory 104. The CPU 102 is operable to perform any number of processing tasks by executing program instructions. In embodiments the processor 102 may include any number of suitable auxiliary processors or microprocessors. The processor 102 may include a cache memory 104 that is often operative to increase the speed of processing tasks performed by the processor 102.

The I/O adapter 126 connects a variety of input and output devices to the computer 100. The memory 106 may include any type of suitable memory such as, for example, magnetic, solid state, disk-based storage, drum-based storage, random access memory (RAM) 110, and read only memory (ROM) 108. The operating system of the system 100 may be stored in the memory 106. The communications adapter 116 is operative to facilitate communications between the system 100 and a network 118. The network 118 may include, for example, a local area network, a wide area network or the Internet. The system 100 may connect to the network 118 via, for example, a wired or wireless connection. The display adapter 122 is operative to communicably connect a display 124 to the system 100. The display may include any type of suitable display such as, for example, a desktop display, a touch screen, or a mobile display. The GPU 120 includes a processor that is operative to generate graphical data that may be sent to the display 124 for presentation to a user. The interface adapter 128 provides an interface between peripheral devices and the system bus 114. The peripheral devices may include, for example, a mouse 130, a speaker 132, and a keyboard 134, sensors, and actuators, among others.

The memory 106 may store computer-readable and computer-executable instructions. The instructions implement logical functions. The operating system 112 may control the operations of the system 100 and the functions of other software programs or operations.

Memory can also include program instructions for Engine 1, configured to improve the wellness of a user.

According to embodiments, computer 100 can include a mobile communications adapter. Mobile communications adapter can include GPS, cellular, mobile, and/or other communications protocols for wireless communication.

In embodiments, computer 100 can further include communications adapter 116 for coupling to a network 118.

The embodiments described herein provide a system 100 (of FIG. 1) that is operative to allow users, e.g., consultants, to review business data from potential client companies and identify problems the organization may be facing. The business data may include, for example, a type of industry, type of firm, revenue, number of employees, accounting data, human resources data, customer relationship data and industry benchmarking data. The users may analyze these identified problems and proscribe solutions that may be implemented by the organization to address the identified problems. Such an interaction may help an organization identify users that may be candidates for hiring as a consultant or other roll based on their credentials, data analysis, and their proscription of general solutions for addressing the identified problems.

For example, an organization (client) may have their organization entered (onboarded) into the system 100 by answering a number of questions that may be used to categorize the client. A client may, for example, identify an industry of the client, a type of organization, the revenue of the client, a number of employees, information on how the system 100 or a user may access data streams, types of platforms used by the client, and the identification or provision of client data such as, for example, accounting data, human resources data, customer relationship management data, marketing analytics data, sales-oriented customer relationship management data, task management data, project management data, productivity systems data, supply chain data, shipping data, customer service data, information technology data, and industry benchmarking data.

The categories corresponding to the questions addressed by the client may be updated by the system 100 if the system determines that the answer to a question is erroneous. For example, if the system 100 or a user finds data such as financial data that is associated with the client that does not match the answers provided by the company, the system 100 may update the erroneous category.

For example, an organization may provide access to financial data associated with the client to the system 100. Though, in embodiments, any type of client data may be accessed by the user such as, for example, sales figures, human resource records, research and development records, or marketing records. Other records include all available sales and marketing activity data and associated metrics including but not limited to lead generation, lead numbers, lead conversions, sales funnel records, calls and door knocks per day, emails per day, sales follow-ups, marketing campaigns, clickthrough rates, website visitors, prospect engagement records, all available customer relationship data and associated metrics including but not limited to number of customers, customer relationship period (length of time), customer churn rate, customer satisfaction ratings, and net promotor scores. Further the client data may include all available human resources data and associated metrics including but not limited to number of employees, length of tenure, titles, positions, organizational structure, reporting structure, disciplinary actions, promotions, salaries, benefits, all available financial & accounting data and associated metrics including but not limited to profit and loss, balance sheet, cash flows, accounting and reporting method used, current and long term assets, current and long term liabilities, cash on hand, accounts payable, accounts receivable, and annual and monthly revenues. Other client data may include all available productivity data and associated metrics including but not limited to user productivity data like email activity, chat and other non-email communication activity, phone activity, internet activity, software application usage, all available project and task management data and associated metrics, and including but not limited to number of tasks and projects created, assigned, in progress, and completed.

One or more users may receive the data that is associated with the client from the system 100. The client may be assigned categories that correspond to attributes of the client. These categories may include, for example, industry (professional services, manufacturing or medical for example), company type (such as architecture, engineering, or accounting), a number of employees, annual revenue, revenue per employee, or net income.

Financial data in embodiments, may be provided to a user in a manner that preserves the anonymity of the client. For example data presented to a user will often not include the company name, company location, employee names, addresses, or other identifiers such as employer identifier numbers or social security numbers. In some embodiments, the user may know the identity of the client. In some embodiments, the financial data may only be available to one or more users for a limited amount of time. In embodiments, a user may have a quota of clients (or organizational or client data) that the user may access over a particular period. In embodiments the system may limit the access of users to client data based on a subscription level or an access level of a user.

In embodiments the financial data may include any type of financial data associated with the client such as, for example, sales figures, profit and loss statements, payroll information, banking records, or tax records among others.

In operation, the system makes the financial data available to the users. In embodiments, a user may have access to or be given an opportunity to select and access financial data from one or more clients.

Once the user selects the financial data, the user may review and analyze the data. In embodiments, the user may be given a particular time period to review and analyze the data. After the time period, in embodiments, the user access to the data may be revoked.

Once the user has analyzed the data, the user may perform discovery using the data. The user may use manual or automated analytical tools that provide insights into the data or other information. The user may draft an analysis or opinion based on the data. The analysis may include, for example, a recommendation or prescription, either in part or in full, that is directed towards correcting any type of organizational problems that the user has identified in the data. In other words, the user provides an identification of a problem of the client that has been identified during the analysis by the user.

The analysis is associated with a number of categories. Some of the client categories may be assigned by the system 100 following the receipt of the answers provided by the client when the client is onboarded onto the system as discussed above. In this regard, the analysis may be associated by the user with user categories associated with the analysis. The analysis may be associated with user categories directed to the analysis such as, for example, the type of recommended consulting engagement related to the analysis. The user categories associated with the analysis by a user may include other criteria associated with the analysis such as, for example, that the client is missing a leadership resource, or that there is a lack of accountability in some area of the business of the client. A user may include a variety of defined categories in an insight. Examples of these categories are sales, marketing, operations, finance, accounting, human resources and leadership. In embodiments other secondary categories may be included under some categories such as, for example logistics and research that may be found hierarchically under operations.

The analysis, the user categories and the client categories are used to generate an insight by the system 100. Once the user has completed the analysis and associating the analysis with the appropriate categories he insight is provided to the client. The client may view the insight and determine whether the insight is helpful. In embodiments, the client may provide a score associated with the insight that may be used as feedback to provide a ranking of users. Though in the present illustrated embodiment one user insight is discussed, any number of users may provide insights to a client based on the same, similar, or dissimilar client data provided to the users by the system 100.

In embodiments, the user or users may submit a qualitative score or health score associated with the organization of the client when submitting an insight. This qualitative score may be based on several factors including, for example, the health or quality of the marketing, sales, human resources, operations, finance, accounting, and leadership of the organization. In this regard, the user may associate a score with each of the factors individually or may associate a single score with the organization. In embodiments, the system 100 (of FIG. 1) may use individual scores for one or more of the factors and generate an overall qualitative score of the organization as a function of one or more of the factors listed above. The score may be expressed in any number of ways including, for example, an alpha numeric score or another type of visual representation such as colors associated with the score.

In embodiments the insight may be anonymized and posted by the system 100 for other users or clients to review. In this regard, the categories associated with the insight may be used to match the insight to other clients who were not originally associated with the insight. In other words, an insight that was developed by a user for a particular client may be matched (using the categories associated with the insight) to other similar clients. Thus, an insight directed to a first client may be sent to a second client that has similar categories as the first client. Such an arrangement allows a single insight to be accessed and used by numerous clients. Such insights are stored in an insight library for access by any number of clients.

In this regard, a client may review an insight and decide to engage a user for consulting or other types of services often related to the insight. For example, once a client receives an insight from a user, the client may decide that the insight was helpful and would match their needs. The user may decide to hire or contact the user to provide further services. The insight may provide an introduction or another way for the client to contact the user for the client to pursue further services from the user.

In embodiments, it may be desirable for the client to provide qualitative feedback with respect to the insight and/or the quality of the engagement with the user. In this regard, the client may review the insight and determine whether the insight was useful. The client may then apply an insight score to the insight based on the usefulness of the insight or other factors associated with the insight. The insight score may include an alphanumeric score or a visual representation of the score. The insight score associated with the insight may be used to rank users based on their cumulative insight scores for any number of insights. Users with higher insight scores may be presented to clients more often or more prominently.

In embodiments, engagements between a user and a client may be rated by the client. In this regard, following or during an engagement, a client may apply and enter an engagement score associated with the engagement. This engagement score may be used to rate users cumulatively based on one or more engagement scores. The engagement score may include any type of alphanumeric or visual score type. Users with higher engagement scores may be presented to clients more prominently or more frequently to encourage users to facilitate more useful or quality engagements.

Another method for rating users may include, for example, determining the number of insights, engagements, or other activities either alone or in combination that are performed by a user. Such an activity rating may allow users that are more active on the system 100 to have a higher activity score than users who are not as active. As such, highly active users may be presented more often or more prominently to clients to reward the activity of the user.

The insight scores, engagement scores, and activity scores alone or in combination, may be used to present users more prominently or frequently to clients. The scores may also be used to rank users with respect to each other. Thus, generally “better” users with higher insight, engagement, activity scores, or any combination of one or more of these factors, may be presented to clients more prominently or more frequently such that the clients have a greater chance of being matched with a user that will meet the needs of the clients. Such an arrangement may provide better services to clients.

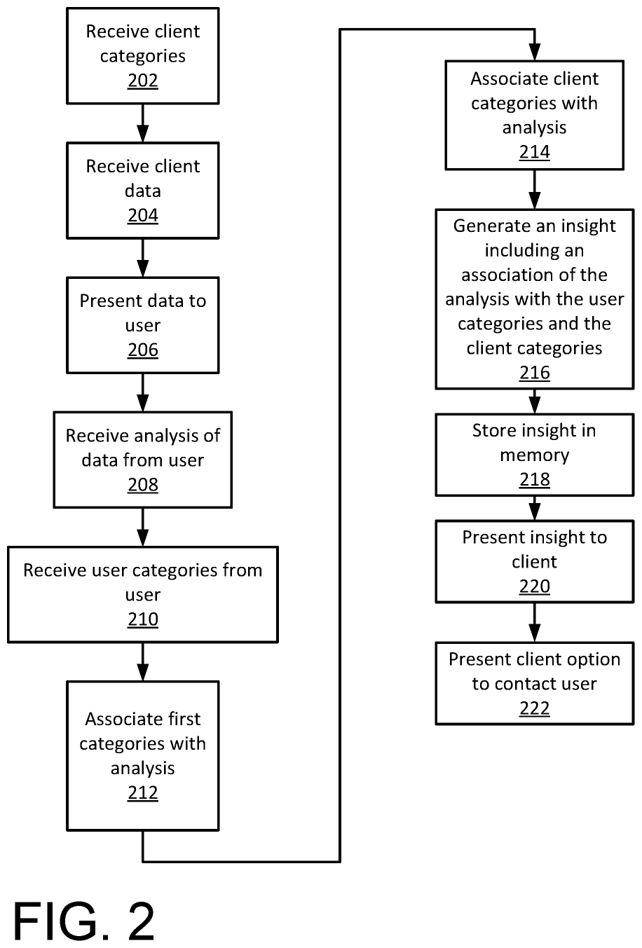

FIG. 2 illustrates a block diagram of an exemplary method for pairing users (e.g., consultants) with clients (e.g., business representatives). In this regard, in block 202 the system 100 (of FIG. 1) receives client categories that may be, for example, inputted by the client during a client onboarding process or during another period in the process. Client categories may include, for example, the type of industry the client is in, the type of firm of the business, annual revenue of the firm, and number of employees. In block 204 the client data is received by the system 100. The client data may include, for example, accounting or financial data, human resources data, and customer relationship data. Examples of client data include marketing analytics data, sales-oriented customer relationship management, task management data, project management data, productivity systems data, supply chain data, shipping data, customer service data, information technology data, and industry benchmarking data.

Client categories may include, for example, professional services firms including architecture, accounting, engineering, client management, creative services, marketing, advertising, public relations, project management, logistics, legal services, accounting, bookkeeping, talent and recruiting services, information technology services. Other non-professional services firms include wholesale, retail, manufacturing, medical, biomedical engineering, life sciences, agriculture, pharmaceutical.

The client data may be organized into a client data profile that may be created from any available business data.

The data is presented to a user in block 206. The data may be presented to the user by the system 100, or in embodiments, the access to the data may be presented to the user such that the user may access the data from, for example, a third party source. In embodiments, the data may be provided to the user or access to the data may be given to the user such that the user may retrieve the data for presentation to the user. The system 100 receives an analysis of the data from the user in block 208. In block 210 the system 100 receives categories associated with the analysis by the user. Such categories may include, for example, that the client is missing leadership resources, or lacks accountability in an aspect of their business.

In block 212, the system 100 associates the categories provided by the user with the analysis. In block 214, the system associates the client categories with the analysis. The system generates an insight, which includes the analysis of the data or other materials provided by or made available by the system, recommendations or comments by the user, the associated user categories, and the associated client categories in block 216.

In block 218, the insight is stored in memory 106 (of FIG. 1). The system 100 may present the insight to the client in block 220. The client is presented with an option to contact the user in block 222. In some embodiments, the client may contact the user through an engagement or hiring process. The contact in embodiments may include a request for engagement or other textual or non-textual method of communication. For example, the client may appreciate the insight and decide to engage or hire the user. In this regard, the client may select an option to engage or hire the user responsive to receiving the insight.

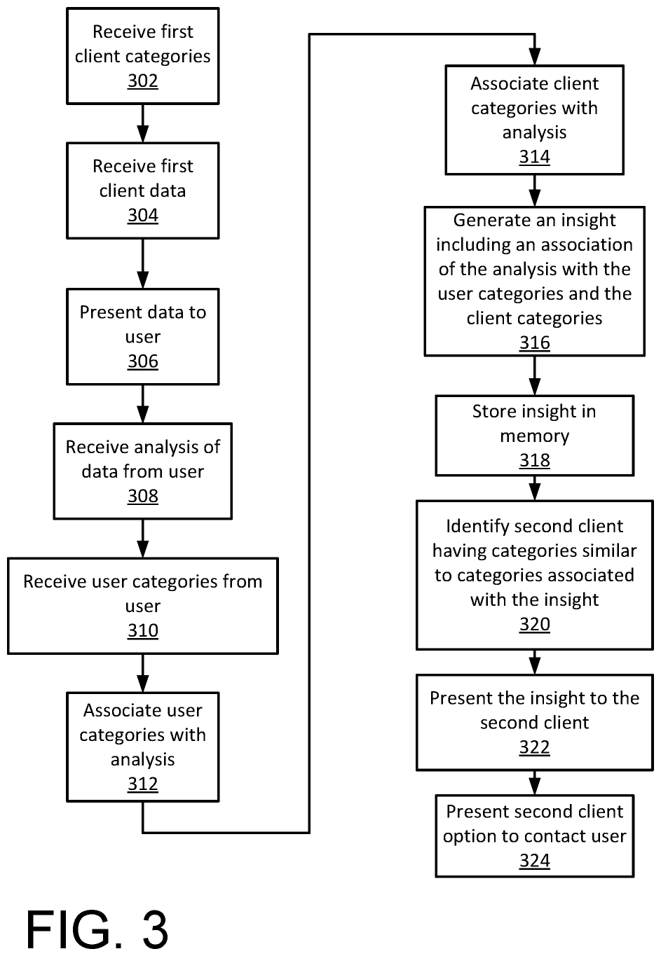

FIG. 3 illustrates a block diagram of another exemplary method for pairing users with clients. In this regard, in block 302 the system 100 (of FIG. 1) receives client categories that may be, for example, inputted by the client during a client onboarding process or during another period in the process. Client categories may include, for example, the type of industry the client is in, the type of firm of the business, annual revenue of the firm, and number of employees. In block 304 the client data is received by the system 100. The client data may include, for example, accounting or financial data, human resources data, and customer relationship data and other data described above.

The data is presented to a user in block 306. The data may be presented to the user by the system 100, or in embodiments, the access to the data may be presented to the user such that the user may access the data from, for example, a third party source. In embodiments, the data may be provided to the user or access to the data may be given to the user such that the user may retrieve the data for presentation to the user. The system 100 receives an analysis of the data from the user in block 308. In block 310 the system 100 receives categories associated with the analysis by the user. Such categories may include, for example, that the client is missing leadership resources, or lacks accountability in an aspect of their business.

In block 312, the system 100 associates the categories provided by the user with the analysis. In block 314, the system associates the client categories with the analysis. The system generates an insight, which includes the analysis of the data or other materials provided by or made available by the system, recommendations or comments by the user, the associated user categories, and the associated client categories in block 316. In block 318, the insight is stored in memory 106 (of FIG. 1).

In block 320 the system 100 identifies a second client that has categories that are similar to client categories and/or user categories that are associated with the insight. Thus, associations may include user categories that the user has associated with the analysis that form portions of the insight and associated client categories. In this regard, user categories and client categories associated with the analysis, which form at least part of the insight may be matched with user and client categories associated with the second client.

In block 322, the insight is provided to the second client. Thus, the second client having similar attributes to the first client may receive the insight. In this regard, the insight may be distributed to any number of clients. These clients may access the insight and find may the insight useful. The clients are presented with an option to contact the user in block 324. The option may be provided in, for example, a link that provides contact information about the user such as an email address, phone number, contact information, a messaging page that allows the client to send a message to the user, or a button or other input tool on a graphical user interface or display that allows the client to communicate with the user. In some embodiments, the client may contact the user through an engagement or hiring process. The contact in embodiments may include a request for engagement or other textual or non-textual method of communication. For example, the client may appreciate the insight and decide to engage or hire the user. In this regard, the client may select an option to engage or hire the user responsive to receiving the insight.

In embodiments described herein the system 100 provides a user with information related to a client. The information may be used by the user to analyze aspects of the client organization. The user analysis and categories that may be used to describe the analysis along with categories associated with the client are used to generate an insight. The insight may be provided to one or more clients that may use the insight to improve aspects of their organization. The insight may be used to contact the user to, in some cases, employ the user in a capacity to assist the organization in any number of matters. Such matters may or may not be associated with the insight.

The present invention may include a computer program, a method, system, and/or a computer program product in any level of integration. A computer program product can comprise of any type of computer readable storage medium that includes computer readable program instructions that causes a processor to implement some or all aspects of the invention.

The computer readable storage medium may include any suitable device that may store instructions for use by a computer, processor or other similar device. The computer readable storage medium may include, for example a random access memory, a read only memory, a flash memory, a magnetic or light readable disk. A computer readable storage medium as used herein does not include transitory signals such as, for example, electromagnetic waves.

The computer readable program instructions may be received by a computer or processing device by any suitable process such as, for example, wireless, wired, or optical transmission via a network or other communications devices or processes.

Each block of the illustrations and block diagrams described herein can be implemented by computer readable program instructions, and input to a processor of a computer to carry out or execute the computer readable program instructions.

The descriptions of the various embodiments are disclosed for illustration, but are not intended to limit the disclosed embodiments. Many modifications and variations will be apparent to those of ordinary skill in the art without departing from the scope of the described embodiments.

What is claimed is:

1. A method comprising:
providing a user access to data associated with a client;
receiving an analysis of the data from the user;
receiving a user category associated with the analysis from the user;
generating an insight that includes the analysis and the user category associated with the analysis;
associating the user with the insight;
storing the insight in a memory; and
outputting the insight to the client.

2. The method of claim 1, wherein the data includes data associated with an organization associated with the client.

3. The method of claim 1, further comprising providing the client with an option to contact the user.

4. The method of claim 1, wherein the user category associated with the analysis includes a description of the analysis.

5. The method of claim 1, further comprising associating a client category with the analysis, wherein the client category includes a description of the client.

6. The method of claim 1, further comprising:
associating a client category with the insight, the client category including a description of the client wherein, a second client is associated with a second client category;
determining whether the second client category associated with the second client is substantially similar to the client category of the client; and
providing the insight to the second client responsive to determining that the second client category of the second client is substantially similar to the client category of the client.

7. The method of claim 6, further comprising providing the second client with an option to contact the user regarding the insight.

8. A system comprising:
a processor communicatively connected to a memory and a display, the processor operative to:
provide a user access to data associated with a client;
receive an analysis of the data from the user;
receive a user category associated with the analysis from the user;
generate an insight that includes the analysis and the user category associated with the analysis;
associate the user with the insight;
store the insight in a memory; and
outputting the insight to the client.

9. The system of claim 8, wherein the data includes data associated with an organization associated with the client.

10. The system of claim 8, further comprising providing the client with an option to contact the user.

11. The system of claim 8, wherein the user category associated with the analysis includes a description of the analysis.

12. The method of claim 8, further comprising associating a client category with the analysis, wherein the client category includes a description of the client.

13. The system of claim 8, wherein the processor is further operative to:
associate a client category with the insight, the client category including a description of the client wherein, a second client is associated with a second client category;
determine whether the second client category associated with the second client is substantially similar to the client category of the client; and
provide the insight to the second client responsive to determining that the second client category of the second client is substantially similar to the client category of the client.

14. The system of claim 13, wherein the processor is further operative to provide an option for the second client to contact the user regarding the insight.

15. A non-transitory computer readable medium including instructions to:
provide a user access to data associated with a client;
receive an analysis of the data from the user;
receive a user category associated with the analysis from the user;
generate an insight that includes the analysis and the user category associated with the analysis;
associate the user with the insight;
store the insight in a memory; and
outputting the insight to the client.

16. The non-transitory computer readable medium of claim 15, wherein the data includes data associated with an organization associated with the client.

17. The non-transitory computer readable medium of claim 15, further comprising providing the client with an option to contact the user.

18. The non-transitory computer readable medium of claim 15, wherein the user category associated with the analysis includes a description of the analysis.

19. The non-transitory computer readable medium of claim 15, further comprising associating a client category with the analysis, wherein the client category includes a description of the client.

20. The non-transitory computer readable medium of claim 15, wherein the instructions are further operative to:
associate a client category with the insight, the client category including a description of the client wherein, a second client is associated with a second client category;
determine whether the second client category associated with the second client is substantially similar to the client category of the client;
provide the insight to the second client responsive to determining that the second client category of the second client is substantially similar to the client category of the client; and
provide an option for the second client to contact the user regarding the insight.
